(19) United States
(12) Patent Application Publication
(10) Pub. No.: US 2025/0220573 A1
(43) Pub. Date: Jul. 3, 2025

(54) CONTROL SYSTEM, ROADSIDE APPARATUS, AND CONTROL METHOD

(71) Applicant: TOYOTA JIDOSHA KABUSHIKI KAISHA, Toyota-shi (JP)

(72) Inventors: Toshiki KASHIWAKURA, Tokyo-to (JP); Chihiro INABA, Tokyo-to (JP); Shoi SUZUKI, Tokyo-to (JP); Tsuyoshi OKADA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/989,470

(22) Filed: Dec. 20, 2024

(30) Foreign Application Priority Data
Dec. 28, 2023 (JP) 2023-223242

(51) Int. Cl. H04W 52/02; H04L 67/12

(52) U.S. Cl. CPC H04W 52/0203; H04L 67/12

(57) ABSTRACT

A control system includes a roadside apparatus, and a server capable of communicating with the roadside apparatus, the roadside apparatus is configured to shift from an operation mode to a sleep mode in which power consumption is reduced more than in the operation mode when a predetermined time period has elapsed after a start of operation, the server is configured to transmit a cancellation instruction for the sleep mode to the roadside apparatus when a first condition has been satisfied, and the roadside apparatus is configured to cancel the sleep mode and return to the operation mode in response to receipt of the cancellation instruction.

### CROSS-REFERENCE TO RELATED APPLICATION

This application claims priority to Japanese Patent Application No. 2023-223242 filed on Dec. 28, 2023, the entire contents of which are incorporated herein by reference.

### TECHNICAL FIELD

The present disclosure relates to a control system, a roadside apparatus, and a control method.

### BACKGROUND

Technology for notifying pedestrians and vehicles of information is known. For example, Patent Literature (PTL) 1 discloses a notification system that, according to the behavior of an automated driving vehicle scheduled to pass through a predetermined traffic area, notifies vehicles other than the automated driving vehicle, pedestrians, and the like of whether they can pass through, warning information, or the like.

### CITATION LIST

### Patent Literature

PTL 1: JP 2023-050629 A

### SUMMARY

In order to make it possible to install roadside apparatuses that notify vehicles and pedestrians of information at any location, it is necessary to reduce power consumption when the roadside apparatuses are portable and designed to be driven by internal batteries. However, PTL 1 does not disclose any technology related to reducing power consumption of the roadside apparatuses. Therefore, there is room for improvement with respect to technology for notifying pedestrians and vehicles of information.

It would be helpful to improve technology for notifying pedestrians and vehicles of information.

A control system according to an embodiment of the present disclosure is a control system including:
a roadside apparatus; and
a server capable of communicating with the roadside apparatus,
wherein the roadside apparatus is configured to shift from an operation mode to a sleep mode in which power consumption is reduced more than in the operation mode when a predetermined time period has elapsed after a start of operation,
the server is configured to transmit a cancellation instruction for the sleep mode to the roadside apparatus when a first condition has been satisfied, and
the roadside apparatus is configured to cancel the sleep mode and return to the operation mode in response to receipt of the cancellation instruction.

A roadside apparatus according to an embodiment of the present disclosure is a roadside apparatus including:
a controller; and
a notification interface capable of communicating with a server,
wherein the controller is configured to:
   shift the roadside apparatus from an operation mode to a sleep mode in which power consumption is reduced more than in the operation mode when a predetermined time period has elapsed after a start of operation of the roadside apparatus;
   upon receiving a cancellation instruction for the sleep mode from the server via the notification interface, cancel the sleep mode and return the roadside apparatus to the operation mode in response to receipt of the cancellation instruction;
   cancel some of functions of the road side apparatus when, in the operation mode, a remaining battery capacity of the roadside apparatus is less than a first reference value; and
   stop the operation of the roadside apparatus when the remaining battery capacity is less than a second reference value.

A control method according to an embodiment of the present disclosure is a control method performed by a roadside apparatus, the control method including:
shifting the roadside apparatus from an operation mode to a sleep mode in which power consumption is reduced more than in the operation mode when a predetermined time period has elapsed after a start of operation of the roadside apparatus;
upon receiving a cancellation instruction for the sleep mode from a server, canceling the sleep mode and return the roadside apparatus to the operation mode in response to receipt of the cancellation instruction;
canceling some of functions of the road side apparatus when, in the operation mode, a remaining battery capacity of the roadside apparatus is less than a first reference value; and
stopping the operation of the roadside apparatus when the remaining battery capacity is less than a second reference value.

According to an embodiment of the present disclosure, technology for notifying pedestrians and vehicles of information is improved.

### BRIEF DESCRIPTION OF THE DRAWINGS

In the accompanying drawings:

FIG. 1 is a block diagram illustrating an example of a schematic configuration of a control system according to an embodiment of the present disclosure;

FIG. 2 is a flowchart illustrating an example of operations of the control system;

FIG. 3 is a flowchart illustrating an example of operations of a roadside apparatus;

FIG. 4 is a schematic diagram illustrating a traffic area; and

FIG. 5 is a schematic diagram illustrating the transition of power consumption modes.

### DETAILED DESCRIPTION

Hereinafter, an embodiment of the present disclosure will be described.

### Outline of Embodiment

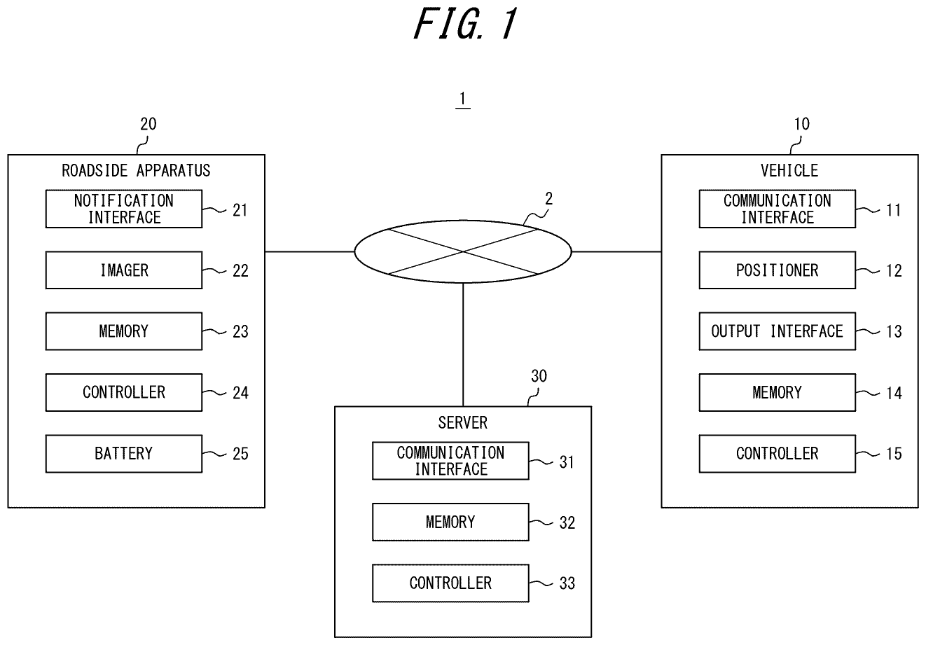

An outline of a control system 1 according to the embodiment of the present disclosure will be described with reference to FIG. 1. The control system 1 includes a vehicle 10, a roadside apparatus 20, and a server 30. The vehicle 10, the roadside apparatus 20, and the server 30 are communicably connected with a network 2 including, for example, the Internet, a mobile communication network, and the like.

The vehicle 10 is an automobile, for example, but is not limited to this and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. In this disclosure, the vehicle 10 is described as an automated driving vehicle 10 with an automated driving function. However, the vehicle 10 is not limited to the automated driving vehicle 10. The number of automated driving vehicles 10 included in the control system 1 may be freely determined. The automated driving vehicle 10 is communicably connected to the roadside apparatus 20 and the server 30 via the network 2.

The roadside apparatus 20 is an information communication apparatus that, upon detecting a pedestrian heading toward the roadway from the camera video, notifies the pedestrian and also notifies the automated driving vehicle 10 approaching the pedestrian. The roadside apparatus 20 is a portable internal battery-powered type and can switch between an operation mode and a sleep mode in which power consumption is reduced more than when operating, in order to save power. Furthermore, the roadside apparatus 20 can deactivate some of its functions during operation. The roadside apparatus 20 is communicably connected to the automated driving vehicle 10 and the server 30 via the network 2.

The server 30 is a computer owned by the administrator (the management center) of the roadside apparatus 20. The server 30 is communicably connected to the automated driving vehicle 10 and the roadside apparatus 20 via the network 2.

First, an outline of the present embodiment will be described, and details thereof will be described later. The control system 1 includes the roadside apparatus 20, and the server 30 capable of communicating with the roadside apparatus 20, the roadside apparatus 20 shifts from an operation mode to a sleep mode in which power consumption is reduced more than in the operation mode when a predetermined time period has elapsed after a start of operation, the server 30 transmits a cancellation instruction for the sleep mode to the roadside apparatus 20 when a first condition has been satisfied, and the roadside apparatus 20 cancels the sleep mode and return to the operation mode in response to receipt of the cancellation instruction.

Thus, according to the present embodiment, if the first condition has been satisfied, the sleep mode of the roadside apparatus 20 is canceled. Therefore, it is possible to reduce the power consumption of the roadside apparatus 20 by canceling the sleep mode of the roadside apparatus 20 only in certain situations and shifting to the sleep mode in other situations, for example, when the automated driving vehicle 10 approaches the roadside apparatus 20 to a certain degree. Thus, the technology for notifying pedestrians and vehicles of information is improved in that the probability of reducing the power consumption of the roadside apparatus 20 is increased.

Next, configurations of the control system 1 will be described in detail.

### Configuration of Vehicle

As illustrated in FIG. 1, the vehicle 10 (the automated driving vehicle 10) includes a communication interface 11, a positioner 12, an output interface 13, a memory 14, and a controller 15.

The communication interface 11 includes at least one interface for communication for connecting to the network 2. The communication interface is compliant with a mobile communication standard such as the 4th generation (4G) standard or the 5th generation (5G) standard, an in-vehicle network (e.g., a Controller Area Network (CAN)), or the like, for example, but is not limited to these. In the present embodiment, the automated driving vehicle 10 communicates with the roadside apparatus 20 and the server 30 via the communication interface 11 and the network 2.

The positioner 12 includes one or more apparatuses that acquire positional information for the automated driving vehicle 10. Specifically, the positioner 12 includes, for example, a receiver compliant with GPS, but is not limited to this example and may include a receiver compliant with any appropriate satellite positioning system. The positional Information is the latitude and longitude of the target point.

The output interface 13 is configured with at least one audio output interface that can output audio, and at least one display interface that can display text or video. The audio output interface is, for example, a speaker that outputs audio information indicating the presence of pedestrians, which is received from the roadside apparatus 20. The display interface is, for example, a display such as an LCD or an organic EL display that outputs information indicating the presence of pedestrians, which is received from the roadside apparatus 20, in the form of text or video. However, the audio output interface and the display interface are not limited to these.

The memory 14 includes one or more memories. The memories are, for example, semiconductor memories, magnetic memories, optical memories, or the like, but are not limited to these. The memories included in the memory 14 may each function as, for example, a main memory, an auxiliary memory, or a cache memory. The memory 14 stores any information used for operations of the automated driving vehicle 10. For example, the memory 14 may store a system program, an application program, embedded software, map information, and the like. The information stored in the memory 14 may be updated with, for example, information acquired from the network 2 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire automated driving vehicle 10.

### Configuration of Roadside Apparatus

As illustrated in FIG. 1, the roadside apparatus 20 includes a notification interface 21, an imager 22, a memory 23, a controller 24, and a battery 25.

The notification interface 21 includes at least one interface for communication for connecting to the network 2. The interface for communication is compliant with, for example, but not limited to, a mobile communication standard, a wired local area network (LAN) standard, or a wireless LAN standard, and may be compliant with any appropriate communication standard. In the present embodiment, the roadside apparatus 20 communicates with the automated driving vehicle 10 and the server 30 via the notification interface 21 and the network 2.

Furthermore, the notification interface 21 includes at least one of the following: (i) a speaker that informs pedestrians of the approach of the automated driving vehicle 10 by audio; (ii) a display that informs the pedestrians of the approach in the form of text or video; and (iii) a signal light that informs the pedestrians of the approach by flashing light, but the information notification method is not limited to these.

The imager 22 is equipped with a video camera 22A, which captures moving images or still images of pedestrians heading toward the roadway.

The memory 23 includes one or more memories. The memories included in the memory 23 may each function as, for example, a main memory, an auxiliary memory, or a cache memory. The memory 23 stores any information to be used for operations of the roadside apparatus 20. For example, the memory 23 may store system programs, application programs, databases, images captured by the imager 22, and the like. The information stored in the memory 23 may be updated with, for example, information acquired from the network 2 via the notification interface 21.

The controller 24 includes at least one processor, at least one programmable circuit, at least one dedicated circuit, or a combination of these. The controller 24 controls operations of the entire roadside apparatus 20.

The battery 25 supplies power to the notification interface 21, the imager 22, the memory 23, and the controller 24. The battery 25 is a rechargeable battery supplied by an external power source or a rechargeable battery that can be removed from the roadside apparatus 20, but is not limited to these.

### Configuration of Server

As illustrated in FIG. 1, the server 30 includes a communication interface 31, a memory 32, and a controller 33.

The communication interface 31 includes at least one interface for communication for connecting to the network 2. The interface for communication is compliant with, for example, but not limited to, a mobile communication standard, a wired local area network (LAN) standard, or a wireless LAN standard, and may be compliant with any appropriate communication standard. In the present embodiment, the server 30 communicates with the automated driving vehicle 10 and the roadside apparatus 20 via the communication interface 31 and the network 2.

The memory 32 includes one or more memories. The memories included in the memory 32 may each function as, for example, a main memory, an auxiliary memory, or a cache memory. The memory 32 stores any information used for operations of the server 30. For example, the memory 32 may store a system program, an application program, a database, information on the roadside apparatus 20 to be managed, and the like. The information stored in the memory 32 may be updated with, for example, information acquired from the network 2 via the communication interface 31.

The controller 33 includes at least one processor, at least one programmable circuit, at least one dedicated circuit, or a combination of these. The controller 33 controls the operations of the entire server 30.

### Flow of Operations of Control System 1

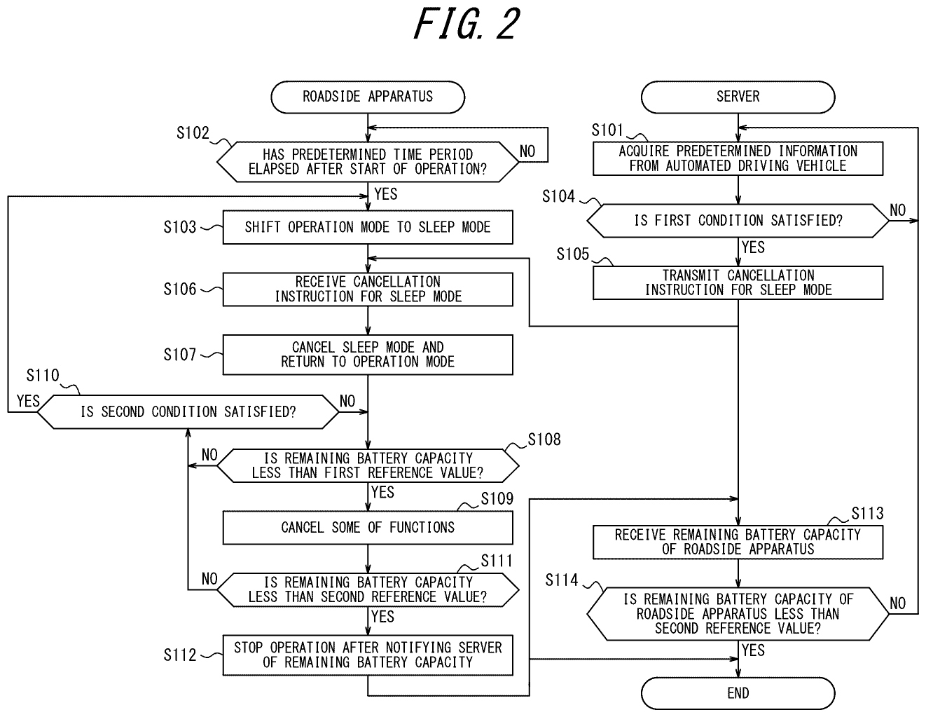

Operations of the control system 1 according to the present embodiment will be described with reference to FIG. 2. These operations relate to reducing the power consumption of the roadside apparatus 20.

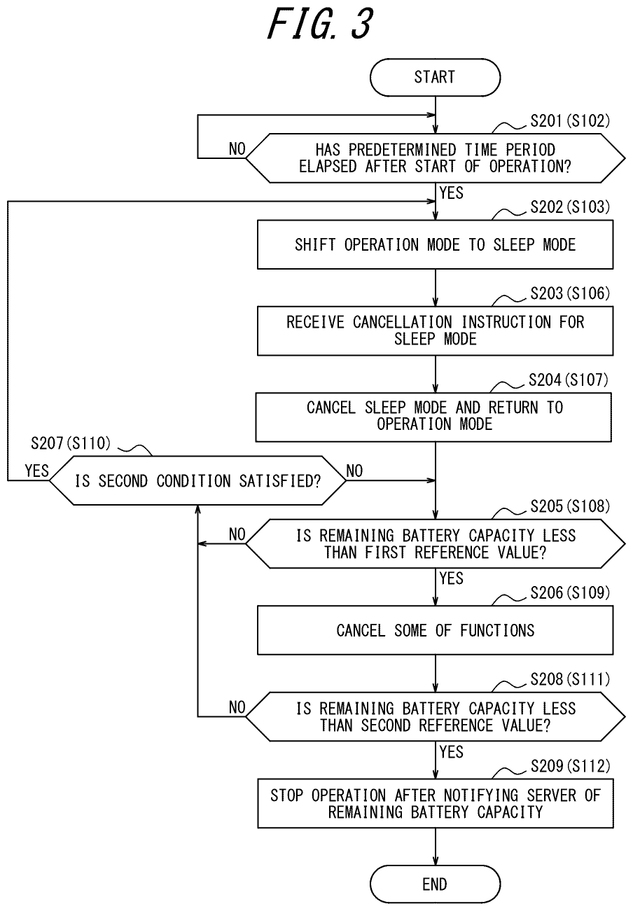

FIG. 3 is a flowchart illustrating an example of operations of the roadside apparatus 20. Since the flowchart of FIG. 3 is common to a portion of the flowchart of FIG. 2, an example of the operations of the control system 1 illustrated in FIG. 2 is described below, and an explanation of an example of the operations of the roadside apparatus 20 illustrated in FIG. 3 is omitted. The corresponding step number in FIG. 2 is shown in parentheses to the right of the step number in FIG. 3. That is, S201 in FIG. 3 corresponds to S102 in FIG. 2, and similarly below, S202 to S103, S203 to S106, S204 to S107, S205 to S108, S206 to S109, S207 to S110, S208 to S111, and S209 to S112.

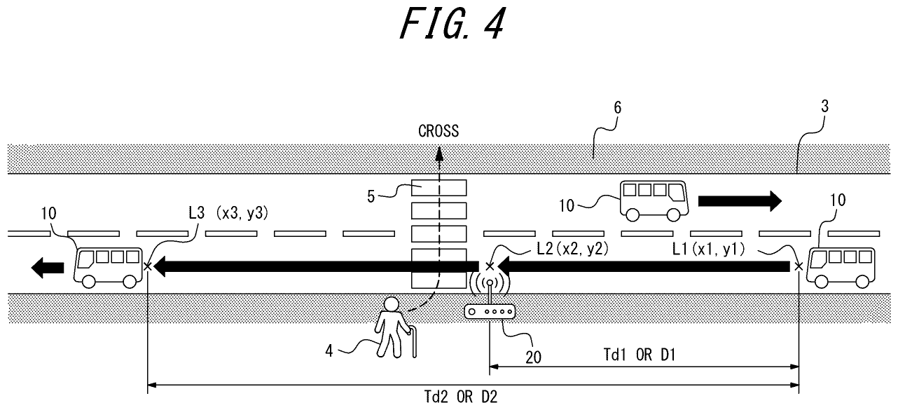

FIG. 4 is a schematic diagram illustrating a traffic area. As illustrated in FIG. 4, the automated driving vehicle 10 travels on a roadway 3, while a pedestrian 4 crosses the roadway 3 at a crosswalk 5 or the like. The roadside apparatus 20 is a portable internal battery-powered type and can be installed at any location. In the example illustrated in FIG. 4, the roadside apparatus 20 is installed on a roadside strip 6 of the roadway 3, for example, in the vicinity of the crosswalk 5.

S101: The controller 33 of the server 30 acquires predetermined information from the automated driving vehicle 10 via the communication interface 31 and the network 2.

The predetermined information includes, but is not limited to, the position L1 (x1, y1) of the automated driving vehicle 10, the vehicle speed S of the automated driving vehicle 10, the scheduled time to pass the point where the roadside apparatus 20 is installed, and the operation date of the automated driving vehicle 10. The server 30 stores in advance the position L2 (x2, y2) of the point where the roadside apparatus 20 is installed and the position L3 (x3, y3) that the automated driving vehicle 10 should reach after the automated driving vehicle 10 passes the position L2 to enable the pedestrian 4 to safely cross the roadway 3.

S102: The controller 24 of the roadside apparatus 20 determines whether a predetermined time period T1 has elapsed after a start of operation of the roadside apparatus 20. If the predetermined time period T1 has elapsed, proceed to S103; if not, return to S102.

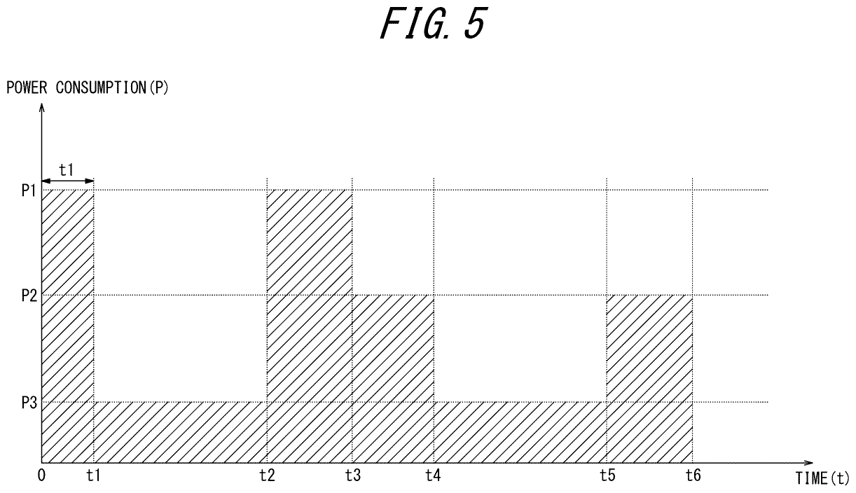

The predetermined time period T1 should be set to a short period of time, such as 5 seconds, 10 seconds, or 30 seconds, for example, to reduce the power consumption of the roadside apparatus 20 as much as possible, but not limited to these. FIG. 5 is a schematic diagram illustrating the transition of power consumption modes. As illustrated in FIG. 5, the roadside apparatus 20 operates in operation mode until the predetermined time period T1 has elapsed after the start of operation. The power consumption P of the roadside apparatus 20 during this period is P1.

S103: The controller 24 of the roadside apparatus 20 shifts the roadside apparatus 20 from the operation mode to the sleep mode in which power consumption is reduced more than in the operation mode.

In this disclosure, the sleep mode refers to a state in which the operation of the roadside apparatus 20 is temporarily suspended in order to reduce the power consumption P of the roadside apparatus 20. In the sleep mode, the controller 24 of the roadside apparatus 20 can receive notifications from the server 30 via the notification interface 21 and the network 2. In the sleep mode, the roadside apparatus 20 is in a power-saving state while maintaining the ability to communicate and return to the operation mode.

When the predetermined time period T1 elapses after the start of operation of the roadside apparatus 20, the controller 24 of the roadside apparatus 20 reduces the power consumption of the roadside apparatus 20 by shifting the roadside apparatus 20 from the operation mode to the sleep mode in which the power consumption is reduced more than in the operation mode. As illustrated in FIG. 5, at a time t1, when the roadside apparatus 20 transitions from the operation mode to the sleep mode, the power consumption P of the roadside apparatus 20 is reduced from P1 to P3.

S104: The controller 33 of the server 30 determines whether the first condition is satisfied. If the first condition is satisfied, proceed to S105; if not, return to S101.

The first condition is at least one of the following: (i) a first time distance Td1 from the automated driving vehicle 10 approaching the roadside apparatus 20 to the roadside apparatus 20 being less than a threshold a; (ii) a time that is a predetermined time period T2 before a scheduled time for the automated driving vehicle 10 to pass the roadside apparatus 20 having arrived; and (iii) a condition of being an operation date of the automated driving vehicle 10.

Time distance is the distance from one point to another expressed in terms of the time required to travel, rather than the spatial distance in kilometers. As illustrated in FIG. 4, for example, the first time distance Td1 is the time required for the automated driving vehicle 10 to travel from the position of its own vehicle to the position of the installation point of the roadside apparatus 20. For the first condition (i), if the position of the automated driving vehicle 10 at the determination time is L1 (x1, y1) and the position of the installation point of the roadside apparatus 20 is L2 (x2, y2), a distance D1 between the position of the automated driving vehicle 10 and the position of the installation point of the roadside apparatus 20 is calculated according to the following formula (1) and the first time distance Td1 is calculated based on the formula (2). S is the vehicle speed of the automated driving vehicle 10.

$$D {1}^{2} = {( x 1 - x 2 )}^{2} + {( y 1 - y 2 )}^{2} \qquad ( 1 )$$

$$Td 1 = D 1 / S \qquad ( 2 )$$

The controller 33 of the server 30 determines whether or not the first condition (i) is satisfied according to the following formula (3).

$$Td 1 < α \qquad ( 3 )$$

S105: When the first condition has been satisfied, the controller 33 of the server 30 transmits a cancellation instruction for the sleep mode to the roadside apparatus 20 via the communication interface 31 and the network 2.

Upon determining that the first time distance Td1 is less than the threshold α, the controller 33 of the server 30 transmits a cancellation instruction for the sleep mode to the roadside apparatus 20. Upon determining that the determination time is a time that is the predetermined time period T2 before the scheduled time for the automated driving vehicle 10 to pass the roadside apparatus 20, the controller 33 of the server 30 transmits a cancellation instruction for the sleep mode to the roadside apparatus 20.

The server 30 may simultaneously transmit a second time distance Td2 when transmitting the cancellation instruction for the sleep mode to the roadside apparatus 20. The second time distance Td2 is the time required for the automated driving vehicle 10 to reach the position L3 (x3, y3) where the pedestrian 4 can safely cross the roadway 3 after passing the position L2 of the point where the roadside apparatus 20 is installed from the position L1 (x1, y1) of the automated driving vehicle 10. A distance D2 from the position L1 to the position L3 of the vehicle is calculated by the following formula (4), and the second time distance Td2 is calculated by the formula (5). S is the vehicle speed of the automated driving vehicle 10.

$$D {2}^{2} = {( x 1 - x 3 )}^{2} + {( y 1 - y 3 )}^{2} \qquad ( 4 )$$

$$Td 2 = D 2 / S \qquad ( 5 )$$

S106-S107: The controller 24 of the roadside apparatus 20 cancels the sleep mode of the roadside apparatus 20 and returns it to the operation mode in response to receipt of the cancellation instruction for the sleep mode.

As illustrated in FIG. 5, the power consumption P increases from P3 to P1 at a time t2 when the roadside apparatus 20 returns from the sleep mode to the operation mode.

S108: The controller 24 of the roadside apparatus 20 determines whether the remaining battery capacity of the roadside apparatus 20 is less than the first reference value. If the remaining battery capacity is less than the first reference value, proceed to S109; if the remaining battery capacity is equal to or greater than the first reference value, proceed to S110.

S109: The controller 24 of the roadside apparatus 20 deactivates some of the functions of the roadside apparatus 20.

The first reference value shall be the remaining battery capacity (%), e.g., 30% of the fully charged capacity, but the first reference value is not limited to 30%. The controller 24 of the roadside apparatus 20 may, for example, limit some of the functions of the notification interface 21 when the remaining battery capacity is less than the first reference value. Specifically, the controller 24 of the roadside apparatus 20 may restrict the notification interface 21 to turn off one of the following: (i) a speaker that notifies the pedestrian 4 of the approach of the automated driving vehicle 10 by audio; (ii) a display that notifies the pedestrian 4 in the form of text or video; and (iii) a signal light that notifies the pedestrian 4 by flashing light. This reduces the power consumption of the roadside apparatus 20 from P1 to P2 at a time t3, when some of the functions of the roadside apparatus 20 are deactivated, as illustrated in FIG. 5. If a pedestrian 4 with visual impairment is detected in the camera video, the controller 24 may respond according to the ability of the pedestrian 4, such as turning the display and signal lights off while turning the speaker on.

S110: The controller 24 of the roadside apparatus 20 determines whether the second condition is satisfied. If the condition is satisfied, return to S103; if not, return to S108.

The second condition is that a time period more than a required time T3, which is equivalent to the second time distance Td2, must elapse from the time when the roadside apparatus 20 returns to the operation mode in response to the receipt of a cancellation instruction for the sleep mode. As mentioned above, the controller 24 of the roadside apparatus 20 receives the second time distance Td2 when receiving the cancellation instruction for the sleep mode. As illustrated in FIG. 4, the automated driving vehicle 10 approaching the roadside apparatus 20 passes the point where the roadside apparatus 20 is installed and heads toward the position L3 where the pedestrian 4 can safely cross the roadway 3. Referring to FIG. 5, it is explained that when the time period more than the required time T3, which is equivalent to the second time distance Td2, has elapsed from the time t2, when the roadside apparatus 20 is returned to the operation mode in response to the receipt of the cancellation instruction for the sleep mode from the server 30, to a time t4, the automated driving vehicle 10 is determined to have reached the position L3 or passed the position L3. Therefore, at the time t4, the controller 24 of the roadside apparatus 20 determines that it is safe for the pedestrian 4 to cross the roadway 3, and again shifts the operation mode to the sleep mode. As illustrated in FIG. 5, the power consumption P is reduced from P2 to P3 at the time t4, when the roadside apparatus 20 again enters sleep mode. However, if the roadside apparatus 20 then again receives a cancellation instruction for the sleep mode from the server 30 in S107, and in response to receipt of the cancellation instruction, the roadside apparatus 20 cancels the sleep mode and returns to the operation mode, the power consumption P of the roadside apparatus 20 increases from P3 to P2 at a time t5 when it returns.

S111: The controller 24 of the roadside apparatus 20 determines whether the remaining battery capacity of the roadside apparatus 20 is less than the second reference value. If the remaining battery capacity is equal to or greater than the second reference value, return to S110; if the remaining battery capacity is less than the second reference value, proceed to S112.

S112: The controller 24 of the roadside apparatus 20 notifies the server 30 of the remaining battery capacity via the notification interface 21 and the network 2, stops operation of the roadside apparatus 20, and terminates information processing by the roadside apparatus 20.

The second reference value shall be, but is not limited to, the remaining battery capacity (%) of the roadside apparatus 20, which is 10% of the fully charged capacity, for example. The controller 24 of the roadside apparatus 20 stops the operation of the roadside apparatus 20 when the remaining battery capacity is less than the second reference value, because the battery 25 needs to be replaced or recharged. As illustrated in FIG. 5, at a time t6, when the roadside apparatus 20 stops operating, the power consumption P is reduced from P2 to 0 (zero).

S113-S114: The controller 33 of the server 30 receives the remaining battery capacity of the roadside apparatus 20 transmitted from the roadside apparatus 20 via the communication interface 31 and the network 2, and determines whether the remaining battery capacity of the roadside apparatus 20 is less than the second threshold value. If the remaining battery capacity is equal to or greater than the second reference value, return to S101; if the remaining battery charge is less than the second standard value, the information processing by the server 30 is terminated.

The controller 33 of the server 30 returns to S101 to continue information processing as long as the remaining battery capacity of the roadside apparatus 20 is equal to or greater than the second threshold. On the other hand, if the remaining battery capacity of the roadside apparatus 20 is less than the second threshold, the battery 25 of the roadside apparatus 20 must be replaced or recharged. Therefore, the server 30 terminates the information processing until the battery 25 in the roadside apparatus 20 is replaced or recharged and the roadside apparatus 20 is put back into operation.

As illustrated in the power consumption mode transition diagram of FIG. 5, the present embodiment enables the reduction of power consumption of the roadside apparatus 20 by introducing a sleep mode and deactivating some of the functions of the roadside apparatus 20, as compared to the case where the roadside apparatus 20 is operated in the operation mode.

As described above, the control system 1 according to the present embodiment includes the roadside apparatus 20, and the server 30 capable of communicating with the roadside apparatus 20, the roadside apparatus 20 shifts from an operation mode to a sleep mode in which power consumption is reduced more than in the operation mode when a predetermined time period has elapsed after a start of operation, the server 30 transmits a cancellation instruction for the sleep mode to the roadside apparatus 20 when a first condition has been satisfied, and the roadside apparatus 20 cancels the sleep mode and return to the operation mode in response to receipt of the cancellation instruction.

According to this configuration, if the first condition has been satisfied, the sleep mode of the roadside apparatus 20 is canceled. Therefore, it is possible to reduce the power consumption of the roadside apparatus 20 by canceling the sleep mode of the roadside apparatus 20 only in certain situations and shifting to the sleep mode in other situations, for example, when the automated driving vehicle 10 approaches the roadside apparatus 20 to a certain degree. Thus, the technology for notifying pedestrians and vehicles of information is improved in that the probability of reducing the power consumption of the roadside apparatus 20 is increased.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or a single component, step, or the like can be divided.

For example, an embodiment in which a general purpose computer functions as the roadside apparatus 20 according to the above embodiment can also be implemented. Specifically, a program in which processes for realizing the functions of the roadside apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A control system comprising:
a roadside apparatus; and
a server capable of communicating with the roadside apparatus,
wherein the roadside apparatus is configured to shift from an operation mode to a sleep mode in which power consumption is reduced more than in the operation mode when a predetermined time period has elapsed after a start of operation,
the server is configured to transmit a cancellation instruction for the sleep mode to the roadside apparatus when a first condition has been satisfied, and
the roadside apparatus is configured to cancel the sleep mode and return to the operation mode in response to receipt of the cancellation instruction.

2. The control system according to claim 1, wherein the first condition is a first time distance from an automated driving vehicle approaching the roadside apparatus to the roadside apparatus being less than a threshold, a time that is a predetermined time period before a scheduled time for the automated driving vehicle to pass the roadside apparatus having arrived, and/or being an operation date of the automated driving vehicle.

3. A roadside apparatus comprising:
a controller; and
a notification interface capable of communicating with a server,
wherein the controller is configured to:
shift the roadside apparatus from an operation mode to a sleep mode in which power consumption is reduced more than in the operation mode when a predetermined time period has elapsed after a start of operation of the roadside apparatus;
upon receiving a cancellation instruction for the sleep mode from the server via the notification interface, cancel the sleep mode and return the roadside apparatus to the operation mode in response to receipt of the cancellation instruction;
cancel some of functions of the road side apparatus when, in the operation mode, a remaining battery capacity of the roadside apparatus is less than a first reference value; and
stop the operation of the roadside apparatus when the remaining battery capacity is less than a second reference value. in

4. The roadside apparatus according to claim 3, wherein the controller is configured to shift the roadside apparatus again from the operation mode to the sleep mode when a second condition has been satisfied after returning the roadside apparatus to the operation mode in response to the receipt of the cancellation instruction for the sleep mode.

5. A control method performed by a roadside apparatus, the control method comprising:
shifting the roadside apparatus from an operation mode to a sleep mode in which power consumption is reduced more than in the operation mode when a predetermined time period has elapsed after a start of operation of the roadside apparatus;
upon receiving a cancellation instruction for the sleep mode from a server, canceling the sleep mode and return the roadside apparatus to the operation mode in response to receipt of the cancellation instruction;
canceling some of functions of the road side apparatus when, in the operation mode, a remaining battery capacity of the roadside apparatus is less than a first reference value; and
stopping the operation of the roadside apparatus when the remaining battery capacity is less than a second reference value.
